(19) United States
(12) Patent Application Publication
(10) Pub. No.: US 2008/0185455 A1
(43) Pub. Date: Aug. 7, 2008

(54) ASPHALT RELEASE AGENT AUTOMATED SPRAY SYSTEM

(75) Inventor: Jason Crum, Carrollton, TX (US)

Correspondence Address: GREENLEE WINNER AND SULLIVAN P C, 4875 PEARL EAST CIRCLE, SUITE 200, BOULDER, CO, 80301, US

(73) Assignee: BG Chemical, LP, Dallas, TX (US)

(21) Appl. No.: 11/969,710

(22) Filed: Jan. 4, 2008

Related U.S. Application Data
(60) Provisional application No. 60/883,602, filed on Jan. 5, 2007.

(51) Int. Cl. B05B 12/12; B05B 12/08; B05B 15/04; B05B 17/04; B05D 1/40; B05D 1/02

(52) U.S. Cl. 239/1; 239/67; 239/69

(57) ABSTRACT

An automatic vehicle spraying system comprising a spray apparatus positioned on a boom. The spray apparatus is not rigidly fixed to the boom, but instead is able to be raised and lowered from the boom. A vertical sensor and a horizontal sensor detect when a vehicle passes underneath the spray apparatus and transmit an electronic signal to a programmable logic controller. The controller then determines if the vehicle is in the proper position, causes an actuator to lower the spray apparatus from the boom toward the vehicle surface, and causes the spray apparatus to begin spraying a fluid onto the appropriate vehicle surface. In particular, this invention is useful for the application of asphalt release agents to trucks used to transport asphalt.

### CROSS-REFERENCE TO RELATED APPLICATION

This application claims priority from U.S. Provisional Patent Application No. 60/883,602 filed Jan. 5, 2007, which is incorporated by reference herein to the extent that there is no inconsistency with the present disclosure.

### BACKGROUND OF THE INVENTION

In hot-mix asphalt production, the final asphalt product is transported from the production plant to jobsites in various types of large trucks and vehicles. The hot asphalt has a tendency to adhere to the surfaces of the vehicle bed as it cools during transportation. To prevent asphalt from sticking to the vehicle, lubricating materials known as asphalt release agents are applied to the vehicle bed prior to loading the asphalt.

Asphalt release agents are most commonly liquids, oils, or foams which can be applied manually or by automatic spray systems to a vehicle bed or other surface by sponging, rolling, wiping, painting or spraying. One common method of applying a release agent involves an operator or other personnel spraying the vehicle bed with a wand or spray gun immediately prior to asphalt being loaded onto the vehicle. In most manual applications, the driver either climbs into the vehicle bed or parks next to a scaffold in order to spray the asphalt release agent into the vehicle bed with various types of hand spray apparatuses. These manual application methods are undesirable in the industry for several reasons. To begin with, areas in the vehicle bed may be left untreated because the operator is not always able to spray all of the areas while standing outside of the vehicle bed. Additionally, manual application causes inconsistent amounts of release agent to be applied to the vehicle and there is also the risk that too much or too little release agent will be applied to the vehicle. More importantly, most manual application methods require the operator to park the vehicle and leave the cab of the vehicle to apply the asphalt release agent. This is both very time consuming and can result in accidents caused by slipping and inadvertent movement by the vehicle.

In more efficient methods, the operator of the truck drives through an automated spray system having an overhanging boom with one or more spray nozzles (automated spray systems as known in the art are generally described in “Contractor Driven to Improve Truck Movement,” Asphalt Contractor, April 19995, pp. 32 and 34). As the truck passes underneath the boom, the nozzles spray the release agent onto the truck bed. This method is advantageous because the driver does not have to leave the cab of the truck. While such automated systems have eliminated many of the problems associated with manual application methods, new problems have emerged.

There are many different vehicle designs used in the asphalt transportation industry and typically there are several types of vehicles found at any given production plant. However, many of the current automated spray systems are limited to specific types of vehicles and are unable to successfully apply asphalt release agent to all of the different kinds of vehicles present at the production plants. Thus, it is necessary for an automatic spray system to be able to accommodate vehicles of different types and dimensions.

Many of the current automatic spray systems utilize photo-electric emitters and sensors that detect the presence of a vehicle and activate a timer, giving the driver a limited period of time to correctly position the vehicle underneath the spray nozzles before the system is activated (U.S. Pat. No. 6,863,223). If the vehicle is not in the correct position, the release agent is applied to whatever surface, such as the hood or windshield, that is beneath the spray nozzle. Alternatively, some automated spray system designs (U.S. Pat. No. 6,957,780) require that the driver enter the type of vehicle into the system so that the system recognizes the type of vehicle and applies the release agent according to the specific dimensions of the vehicle. As there is a wide variety of vehicles and because drivers do not always correctly perform this operation, this design is not well received in the asphalt industry. Other methods of vehicle identification include RFID sensors, light reflective tape applied to the vehicle, and operator input keypads. These methods are also undesirable because many asphalt production plants use contract vehicles and drivers that may or may not return to the plant in the future.

The boom in current automated spray systems is generally positioned at a constant height to allow vehicles to pass underneath. The boom must be higher than every part of the vehicle, including the exhaust pipes and cab of the vehicle as well as the vehicle bed. As a result, there is a large distance between the spray nozzle and the surface of the vehicle bed. The drop size of the release agent from the nozzle must be large enough to allow the drop to fall to the vehicle bed. If the spray is too fine, moderate to high winds can blow the spray away from the vehicle bed or the release agent will dissipate into the air. To insure the release agent adequately coats the surface of the vehicle bed, current devices have nozzles that spray large amounts of the release agent, on the order of approximately 1-1.5 gallons per minute, so the drops are big enough to fall to the vehicle bed. To further insure that the release agent adequately coats the surface of the vehicle bed, wind screens are often placed around the spray system to lessen the effect of wind, or the release agent is applied in larger amounts for longer periods of time. Excessive amounts of release agent are unnecessarily sprayed as a result.

In some recent designs, (Reliant I Robotic Spray System, RCAI 940 Calle Amanecer, Unit E, San Clemente, Calif. 92673) the spray apparatus is mechanically lowered into the vehicle bed and guided around the inside perimeter using contact switches. This design would decrease the distance between the spray nozzles and the surface to be sprayed, however, this design also has a high level contact between the spray apparatus and the vehicle which can result in increased damage to either the apparatus of the vehicle. Preferably, an automated spray system would not come in contact with the vehicle to be sprayed. Additionally, several vehicle designs used to transport asphalt would prohibit or restrict the use of inside perimeter contact switches.

What is needed is a simple, quick and more efficient spray system for applying a fluid, particularly an asphalt release agent, to a vehicle, where the spray system can be used with a very high percentage of the truck and vehicle designs common in the industry.

### SUMMARY OF THE INVENTION

The present invention provides a novel fluid application spray system and methods for spraying a truck or other vehicles. The spray system resembles a crane or a davit extending over a truck or other type of vehicle. The system includes a spray apparatus having one or more spray nozzles positioned above the vehicle, wherein the spray apparatus is lowered from the boom to slightly above the vehicle surface. Sensors and a controller are used to detect the presence of a vehicle and to determine how far to lower the spray apparatus. By reducing the distance between the spray nozzles and the vehicle being sprayed, smaller amounts of fluid are needed to coat the vehicle surface and a more accurate application is performed. Once application of the fluid has begun, the spray apparatus is automatically retracted if any physical contact or interference between the spray system and the vehicle is imminent or is detected. It is believed the present invention is unique in that it combats any wind issues while retaining a contact free design.

In one embodiment, the system of the present invention comprises a frame support; a boom having a proximal end and a distal end, wherein the proximal end of the boom is connected to the frame support; a spray apparatus positioned below the distal end of the boom; a hose array attached to the spray apparatus, wherein the hose array extends along the boom and down the frame support; an actuator attached to the frame support and operationally attached to the hose array; a vertical sensor positioned at or near the distal end of the boom and a horizontal sensor positioned at or near the frame support, wherein the sensors are able to produce an output signal when a vehicle passes underneath the spray apparatus. This invention also includes a controller able to receive the output signals from the vertical and horizontal sensors, wherein the controller causes the actuator to extend and retract. When the actuator extends, the actuator will move the hose array up along the frame support and toward the distal end of the boom, causing the spray apparatus to be lowered from the boom.

The spray apparatus comprises one or more spray nozzles in fluid communication with a hose array. The number and configuration of the spray nozzles can be any number or configuration that enables fluid pumped through the spray nozzles to adequately spray fluid in directions around the spray apparatus, including below the spray apparatus. The spray apparatus is not rigidly fixed to the boom, but is instead attached to a component able to raise and lower the spray apparatus from the boom. In one embodiment, the spray apparatus is attached to the hose array and is lowered when the hose array is advanced up the frame support and toward the distal end of the boom by an actuator. Conversely, the spray apparatus is raised when the hose array is pulled down the frame support and away from the distal end of the boom by the actuator. Optionally, the spray apparatus has a specific weight that is slightly less than the natural return pull force of the hose array and a lowered spray apparatus will automatically retract in the event of power loss or control in the system. In one embodiment, the spray apparatus is raised and lowered by programmable servo motor or stepper motor.

The frame support can be any foundation or frame known in the art able to support the weight and position of the other components of the spray system. Specifically, the frame support allows the boom and spray apparatus to be positioned over a vehicle such as a large bed truck. In one embodiment, the frame support is a metal column or stand having a concrete base for stability. The frame support is primarily vertical, but the frame support, or a portion of the frame support, may be oriented at an angle other than vertical. In one embodiment, the frame support has a height of about 9 to about 13 feet above the ground, allowing most vehicles used to transport asphalt to freely pass under the boom. The boom can be any frame known in the art that is able to support the hose array and spray apparatus. Typically, the boom is oriented in an approximately horizontal position and is long enough to allow the center of a vehicle to be positioned under the spray apparatus without the vehicle contacting the frame support. In one embodiment, the boom comprises a cam, pivot or swivel design that allows the distal end of the boom to swing forward or backward if a vehicle that is too tall or has a raised bed attempts to drive under the spray system and contacts the boom. This design prevents damage to the boom by allowing the free end of the boom to laterally swing away from the direction of the vehicle if pressure is applied.

The actuator is any device used to lower or raise the spray apparatus. The actuator is operationally attached to the hose array. “Operationally attached” with respect to the actuator means that the actuator is connected, either directly or indirectly, to the hose array so that when the actuator is activated, the hose array advances along the frame and boom and can lower or raise the spray apparatus. Any device available in the art able to allow the hose array to advance along the frame support and boom can be used, including pneumatic, hydraulic, electrical and motorized devices. Such devices include, but are not limited to, gears, pulleys, trolleys, servo motors, stepping motors, hydraulic jacks, screw jacks, pneumatic jacks, and electric jacks. The movement of the actuator, and therefore the height of the spray apparatus, is adjusted automatically by way of the sensors and the controller that detect when a vehicle passes underneath the spray apparatus.

The hose array is a long tube that is at least semi-flexible. One end of the hose array is attached to the spray apparatus so that fluid pumped through the hose array will exit through the spray nozzles of the spray apparatus. The other end of the hose array is connected to one or more fluid reservoirs and a pump. Through the hose array, the spray apparatus will be in fluid communication with the fluid reservoirs. A component of this invention is in “fluid communication” with another component when the two components are connected so that a fluid flowing through the first component will continue to flow to the second component. The fluid reservoirs can be connected to the hose array by a series of tubes, hoses, or pipes. The pump is in pumping relation with the fluid reservoir, hose array, and spray apparatus. “Pumping relation” means that the pump is connected to a component containing a fluid so that the pump forces the fluid through the component. Fluid is pumped from the reservoirs through the hose array to the spray nozzles of the spray apparatus. The number and direction of the spray nozzles can be designed according to the requirements of the spray system.

The pump can be any pump known in the art and utilizes air pressure, fluid pressure, or both. If more than one fluid reservoir is used, the different fluid reservoirs can contain the same fluid or different fluids that are mixed together during the spraying process. As used herein, the term “fluid” encompasses liquids, solutions, suspensions, oils, foams, and other substances able to flow freely, having no fixed shape and little resistance to outside stress. In one embodiment of the present invention, the fluid reservoirs contain water and at least one other fluid. In one embodiment, the fluid reservoirs contain an asphalt release agent. The spray time and pressure caused by the pump can be predetermined and modified as necessary for the particular application of the spray system.

Sensors suitable for the present invention can be any sensor known in the art able to detect when a vehicle passes in front of the sensor and able to measure the distance between the sensor and the vehicle surface. Such sensors include, but are not limited to, optical sensors, laser sensors, infrared sensors, and ultrasonic sensors. One embodiment of the present invention comprises a vertical sensor and a horizontal sensor placed along the path of a vehicle passing underneath the spray apparatus. The vertical sensor is placed at or near the distal end of the boom and produces an output signal when an object passes underneath. The horizontal sensor is placed on or near the frame support and produces an output signal when an object passes in front of the sensor. Typically, the horizontal sensor will be positioned in the same direction as the boom so that an object that passes underneath the boom will pass in front of the horizontal sensor. Sensors used to detect the presence of vehicles and the contours of vehicles have been described as part of automated car wash systems (U.S. Pat. Nos. 5,033,490; 4,988,042; 4,718,439 and U.S. Patent Application Publication 2002/0162575).

The controller is a processor such as a microcontroller or a central processing unit of a computer. In one embodiment, the controller is a Programmable Logic Controller (PLC) that receives information regarding the distance to the vehicle in both the vertical and horizontal axis from the sensors. Other automatic spray systems utilize sensors to detect the presence of a vehicle under the spray system; however, the vertical and horizontal sensors of the present invention are both used to determine the presence of the vehicle and the distance of the vehicle surface from the sensor. Thus, the PLC is able to create a profile of the vehicle and determine if the spray apparatus should be lowered to begin the spraying process.

The controller receiving the output signals from the vertical and horizontal sensors adjusts the movement of the actuator in response to the output signals. For example, if the sensors detect that an object, such as a vehicle, is properly positioned underneath the spray apparatus, the controller will cause the actuator to lower the spray apparatus to a certain distance above the object. This distance can be determined and optimized according to the flow rate and spray size of the spray nozzles. The fluid is pumped through the spray nozzles once a vehicle is detected underneath the spray apparatus and the spray apparatus lowered to the proper height. When the sensors detect that the distance between the vehicle surface and the sensors is outside acceptable parameters, i.e. the surface of the vehicle is too high, the controller will cause the actuator to move the spray apparatus to the appropriate height.

In one embodiment of the present invention, operation of the spray system is determined by the PLC based on continuous input from the sensors. In this embodiment, the sensors are either ultrasonic or laser based time-of-flight systems, measuring the distance between the vehicle and the face of the sensor 20 to 200 times a second. The location of the sensors, vertical (Z axis) and horizontal (Y axis), are placed in a fixed position extending anywhere from 1 inch to 4 feet from the center line of the spray apparatus on the vehicle entry side of the system. For example, the vertical sensor may be placed on a beam that is attached perpendicular to the boom and extends up to 4 feet in front of the spray apparatus. With this placement, the vehicle will pass underneath the vertical sensor before passing underneath the spray apparatus. This placement enables the spray system to react in a timely manner to changes in the vehicle profile.

The distance measurements taken from the vertical and horizontal sensors are stored in the PLC or a computer and compared to preset values. The preset values correspond to the profiles of vehicles or vehicle areas to be sprayed, for example a truck bed or truck box having a certain horizontal and vertical profile. When the horizontal and vertical measurements from the sensors fall within the preset values, the PLC will lower the spray apparatus and begin spraying. Additionally, the PLC can utilize certain changes in the vertical profile to trigger the spray sequence. In this instance, if the initial values for a vehicle are recognized to be similar to a preset value, the spray sequence can be initiated by a following change (most likely a large increase) in the measured vertical distance that falls within another specific preset range or window, i.e. the PLC begins the spray sequence when it recognizes the transition from a truck hood or cab to the truck bed or truck box.

Once the spray cycle begins, it is either reset when the vertical sensor measures a distance that is outside of the acceptable target range (greater or less), or the system times out after a predetermined time period elapses. The system will also end the spray cycle if the horizontal sensor measures a distance that is outside the range for a possible target area. The system is able to avoid spraying the hood and cab of the vehicle because there are unique measurable differences (in the X, Y and Z axis) between the hood or cab of the vehicle and the desired spray area, such as the truck bed or truck box. While these measurements will change from truck to truck, they almost always have a similar general shape and similar changes dimensionally from hood/cab area to truck bed or truck box. In this embodiment, the PLC and or computer is programmed to recognize these trigger points regardless of the actual type of truck. There would have to be a radical departure from current truck designs for the system not to recognize the correct trigger points.

The spray system may be set on a moveable track allowing the spray system to move along the length of a stationary vehicle. Alternatively, the spray unit may be stationary and the vehicle may drive forward underneath the spray nozzles. Preferably, a vehicle will drive into the proper position underneath the spray apparatus and remain stopped during the spraying process. A display system or a series of signal lights visible to the driver indicate the status of the spraying process and may indicate if the vehicle is in the proper position, when the driver should stop the vehicle, or when the driver can proceed after the spray sequence is complete. The spray sequence is stopped after a set period of time has elapsed or when a vehicle sensor detects that the vehicle is no longer underneath the spray nozzles.

### BRIEF DESCRIPTION OF THE DRAWINGS

FIG. 1 shows a vehicle underneath a spray system of the present invention where the actuator is extended causing the spray apparatus to be lowered from the boom. In this illustration, the spray apparatus is directly above the bed of the vehicle.

FIG. 2 shows a vehicle underneath a spray system of the present invention where the spray apparatus is retracted (in a raised position). In this illustration, the spray apparatus is directly above the cab of the vehicle.

### DETAILED DESCRIPTION OF THE INVENTION

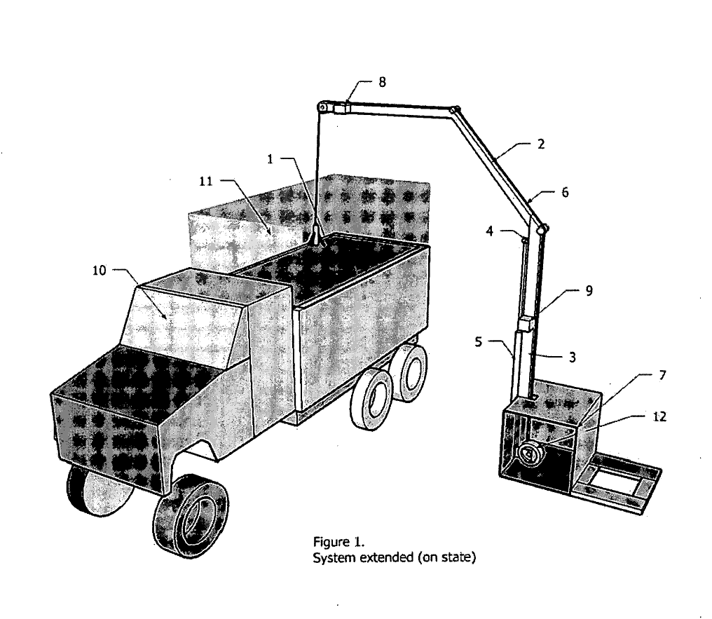

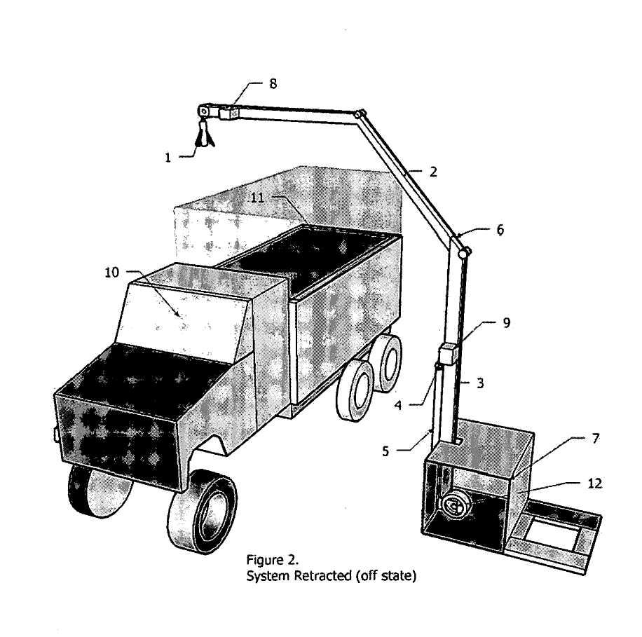

In one embodiment of the invention shown in FIGS. 1 and 2, the spray system comprises a boom 2 attached at one end to a frame support 3. The boom 2 has a proximal end and a distal end, with the distal end defined as the end further away from the frame support 3, and the proximal end of the boom 2 defined as the end connected to the frame support 3. In this embodiment, the boom 2 is bent to form an angle where the proximal end of the boom 2 is at a position between horizontal and vertical, and the distal end of the boom 2 is horizontal. Alternatively, the boom 2 may be straight and extend horizontally from the frame support 3 or extend at an angle between horizontal and vertical from the frame support 3. The spray apparatus 1 is located at the distal end of the boom 2 and is connected to hose array 6.

The hose array 6 is attached to the spray apparatus 1 and runs along the boom 2, down the frame support 3, and is connected to a rolling trolley 4. Moving the trolley 4 along the frame support 3 will likewise cause the hose array 6 to move along the frame support 3 and boom 2. As the hose array 6 is moved up the frame support 3 and toward the distal end of the boom 2, the spray apparatus 1 will be lowered from the boom 2. Conversely, the spray apparatus 1 will be raised when the hose array 6 is moved toward the proximal end of the boom 2 and down the frame support 3.

The actuator 5 is positioned on or next to the frame support 3 and is operationally connected to the hose array 6 through the trolley 4, so that the hose array 6 will be extended or retracted when the actuator 5 moves the trolley 4 along the frame support 3. A retracting hose reel 12 can be used to take up excess slack in the hose array 6 when the spray apparatus is raised and allow smooth release of the hose array 6 as the spray apparatus 1 is lowered.

A vertical sensor 8 is placed toward the distal end of the boom 2 near the spray apparatus 1. The vertical sensor 8 is able to detect when an object, such as a vehicle 10, is located beneath the vertical sensor 8 and can optionally measure the distance between the object and the sensor. Horizontal sensor 9 is positioned approximately halfway up the frame support 3 from the ground, but can be placed at any height that allows the sensor to detect a vehicle passing underneath the spray apparatus 1. In this embodiment, the sensors detect the presence of a vehicle and measure the distance between the sensor and the vehicle surface. The signals from the sensors are transmitted to a programmable logic controller (not shown) which is housed in the electronics and pump enclosure 7.

The hose array 6 is in fluid communication with spray apparatus 1 and one or more fluid reservoirs (not shown). Fluid, preferably asphalt release agent, is pumped from the fluid reservoirs, through hose array 6, and out through spray apparatus 1.

FIG. 1 shows the spray system of the present invention in an “on state” where the actuator 5 extends trolley 4 upwards along the frame support 3 causing hose array 6 to lower spray apparatus 1 from boom 8. At this time, fluid is pumped through the system onto the vehicle target area 11, i.e. the surfaces of the vehicle 10 that need to be coated with asphalt release agent prior to being loaded with hot asphalt.

FIG. 2 shows a spray system of the present invention in an “off state” where a target vehicle 10 is shown underneath the spray apparatus 1 so that the spray apparatus 1 is above the cab of the vehicle 10. The trolley 4 is retracted and the spray apparatus 1 is raised. At this time, no fluid is being pumped through the system.

In one method of use of the present invention, the spray system initially begins with the spray apparatus 1 in the raised position allowing a target vehicle 10 to drive underneath the boom 2 and spray apparatus 1. In particular, the boom 2 and spray apparatus 1 are high enough to allow the cab, exhaust pipes, and other parts of the vehicle 10 to pass underneath. Vertical sensor 8 and horizontal sensor 9 detect the presence of the vehicle 10, measure the distance between each sensor and the vehicle 10, and send electronic signals to a controller (not shown) within the electronics and pump enclosure 7. The controller determines if the area of the vehicle 10 detected by the vertical sensor 8 and horizontal sensor 9 falls within predetermined acceptable parameters. If the dimensions of the detected area of the vehicle 10 fall within the acceptable parameters, the controller causes the actuator 5 to extend the trolley 4 causing the spray apparatus 1 to be lowered a predetermined distance from the boom 2.

Once the spray apparatus 1 has been lowered to the appropriate height, fluid from the fluid reservoir is pumped through the hose array 6 and out through the spray nozzles of spray apparatus 1 onto the vehicle 10. In one embodiment, the fluid is an asphalt release agent. The fluid from the spray apparatus 1 will coat the surface of the vehicle 10. The spray sequence is stopped after a predetermined amount of time elapses. Alternatively, the vehicle moves forward as the fluid is sprayed on the vehicle surface, and the spray sequence is stopped when the vertical sensor 8 or horizontal sensor 9 detect that the appropriate vehicle target area 11 is no longer beneath the boom 2. Optionally, the spray sequence is halted and the spray apparatus 1 raised when the sensors indicate that the vehicle 10 is about to contact the spray apparatus 1.

While the invention has been described with certain preferred embodiments, it is understood that the preceding description is not intended to limit the scope of the invention. It will be appreciated by one skilled in the art that various equivalents and modifications can be made to the invention shown in the specific embodiments without departing from the spirit and scope of the invention. All publications referred to herein are incorporated herein to the extent not inconsistent herewith.

We claim:

1. An automatic vehicle spraying system comprising:
a frame support;
a boom having a proximal end and a distal end, wherein the proximal end of the boom is connected to the frame support;
a spray apparatus positioned below the distal end of the boom, wherein said spray apparatus is able to be lowered from said boom;
a hose array attached to said spray apparatus, wherein the hose array extends along the boom and down the frame support;
an actuator attached to the frame support and operationally attached to the hose array, wherein said actuator raises and lowers the spray apparatus from the boom by moving the hose array; and
a vertical sensor positioned at or near the distal end of the boom and a horizontal sensor positioned at or near the frame support, wherein the sensors are able to produce an output signal when a vehicle passes underneath the spray apparatus.

2. The system of claim 1 wherein the vertical and horizontal sensors are able to measure the distance between the sensors and a vehicle surface.

3. The system of claim 1 further comprising a controller able to receive the output signals from the vertical and horizontal sensors, wherein the controller causes the actuator to raise and lower the spray apparatus from the boom.

4. The system of claim 3 wherein said controller is a microcontroller or a central processing unit of a computer.

5. The system of claim 3 wherein said controller is a programmable logic controller able to receive the output signals from the vertical and horizontal sensors.

6. The system of claim 5 wherein the programmable logic controller is able to generate a profile of a vehicle detected by the vertical and horizontal sensors.

7. The system of claim 6 wherein the programmable logic controller lowers the spray apparatus when the generated vehicle profile is within a range of preset values corresponding to a vehicle or vehicle area to be sprayed.

8. The system of claim 1 further comprising one or more fluid reservoirs in fluid communication with the hose array and spray apparatus.

9. The system of claim 8 further comprising a pump in pumping relation to the one or more fluid reservoirs.

10. The system of claim 9 further comprising a fluid contained within the one or more fluid reservoirs.

11. The system of claim 10 wherein said fluid is an asphalt release agent.

12. A method for applying a fluid to a vehicle comprising the steps of:
(a) providing an automatic vehicle spraying system comprising a frame support; a boom having a proximal end and a distal end, wherein the proximal end of the boom is connected to the frame support; a spray apparatus positioned below the distal end of the boom; a hose array attached to the spray apparatus, wherein the hose array extends along the boom and down the frame support; an actuator attached to the frame support and operationally attached to the hose array; a vertical sensor positioned at or near the distal end of the boom and a horizontal sensor positioned at or near the frame support, wherein the sensors are able to produce an output signal when a vehicle passes underneath the spray apparatus; and a controller able to receive the output signals from the vertical and horizontal sensors, wherein the controller causes the actuator to raise and lower the spray apparatus from the boom;
(b) detecting a vehicle in position underneath the spray apparatus;
(c) measuring the distance between the vehicle and the vertical and horizontal sensors;
(d) comparing the measured distances with preset values;
(e) lowering the spray apparatus when said measured distances fall within said preset values; and
(f) activating a pump in pumping relation with a fluid reservoir containing said fluid, wherein said fluid reservoir is in fluid communication with the spray apparatus and said fluid is pumped from the fluid reservoir to the spray apparatus.

13. The method of claim 12 wherein said pump is stopped when a sensor detects that the vehicle is no longer underneath the spray apparatus.

14. The method of claim 12 wherein said pump is stopped after a predetermined time period elapses.

15. The method of claim 12 wherein said pump is stopped and the spray apparatus is raised when the vehicle contacts said spraying system.

16. The method of claim 12 further comprising generating a profile of a vehicle detected by the vertical and horizontal sensors and comparing the generated profile with a range of preset values.

17. The method of claim 16 further comprising lowering the spray apparatus and activating said pump when the generated vehicle profile is within a range of preset values corresponding to a vehicle or vehicle area to be sprayed.

18. A method for applying an asphalt release agent to a vehicle comprising the steps:
(a) detecting a vehicle in position underneath a spray apparatus attached to a boom, wherein said spray apparatus comprises at least one spray nozzle;
(b) measuring the distance between the vehicle and a vertical and horizontal sensor;
(c) comparing the measured distances with preset values;
(d) lowering the spray apparatus from the boom when said measured distances fall within said preset values;
(e) activating a pump in pumping relation with a fluid reservoir containing asphalt release agent wherein said fluid reservoir is in fluid communication with said at least one spray nozzle, wherein said asphalt release agent is pumped from said fluid reservoir to said at least one spray nozzle; and
(f) stopping said pump and raising the spray apparatus.

19. The method of claim 13 wherein said pump is stopped when a sensor detects that the vehicle is no longer underneath the spray apparatus.

20. The method of claim 13 wherein said pump is stopped after a predetermined time period elapses.
